(19) United States
(12) Patent Application Publication
(10) Pub. No.: US 2025/0110577 A1
(43) Pub. Date: Apr. 3, 2025

(54) INFORMATION PROCESSING SYSTEM, INFORMATION PROCESSING DEVICE, COMMUNICATION DEVICE

(71) Applicant: CANON KABUSHIKI KAISHA, Tokyo (JP)

(72) Inventor: MASAHIKO KONO, Kanagawa (JP)

(21) Appl. No.: 18/903,077

(22) Filed: Oct. 1, 2024

(30) Foreign Application Priority Data
Oct. 3, 2023 (JP) 2023-172128

(51) Int. Cl. G06F 3/023; G06F 40/117

(52) U.S. Cl. CPC G06F 3/0233; G06F 40/117

(57) ABSTRACT

An information processing device that provides a drawing result of a Web page to a communication device based on a request from the communication device, the information processing device comprising: an analysis unit configured to analyze the Web page to determine a text input area; and a transmission unit configured to transmit the drawing result and the information of the text input area to the communication device.

### BACKGROUND OF THE INVENTION

### Field of the Invention

The present invention relates to an information processing system, an information processing device and a communication device, and particular to processing of user interface (UI).

### Description of the Related Art

A technique for drawing a screen using HTML (https://html.spec.whatwg.org) is known. An application that processes HTML is called a browser, and performs drawing in accordance with the HTML specification.

In recent years, it has become possible to execute an application on a cloud service, where a device at that a user is holding transmits operation information of the user to the application on the cloud service, and the device receives a processing result of the application and displays the processing result to the user.

The cloud browser is a browser executed in an application executing environment of the cloud service. The cloud browser performs drawing in response to a request from a device, and saves a drawing result in a database of the same cloud service. The device acquires the drawing result from the database and displays it on the screen of the device.

Here, in a case where the HTML includes an input form, when the user touches the input form on the screen, the device transmits a touch event to the cloud browser. This is because there is only the drawing result on the device and there is no information on the input form. The cloud browser processes the touch event and returns information on whether the touched element is an input form to the device. In a case where it is an input form, the device displays an on-screen keyboard on the screen.

However, when making a determination on whether the place touched by the user is the input form, a time is required for communication between the device and the cloud browser, and thus a delay occurs from the user's touch to the display of the keyboard. Meanwhile, Japanese Patent Laid-Open No. 2012-059248 discloses a technique for determining a place to which input can be made by performing OCR (Optical Character Recognition) on an image.

However, the technique described in Japanese Patent Laid-Open No. 2012-059248 uses OCR, and cannot reflect an accurate position and size of an input form, and furthermore, has a problem that OCR processing takes time.

### SUMMARY OF THE INVENTION

The present invention has been made in view of the above problem, and provides a technique for reducing the time required to display a keyboard in response to a user's touch in a case where a cloud browser is used.

According to one aspect of the present invention, there is provides an information processing system comprising a communication device; and an information processing device that provides a drawing result of a Web page to the communication device based on a request from the communication device; wherein the information processing device includes: an analysis unit configured to analyze the Web page to determine a text input area, and a transmission unit configured to transmit the drawing result and the information of the text input area to the communication device; the communication device includes, a reception unit configured to receive information of the text input area in the drawing result from the information processing device, an accepting unit configured to accept an input operation from a user, a determination unit configured to determine whether or not an operation position of the input operation is included in the text input area, and an activation unit configured to activate a keyboard in a case where the operation position is included in the text input area.

Further features of the present invention will become apparent from the following description of exemplary embodiments (with reference to the attached drawings).

### BRIEF DESCRIPTION OF THE DRAWINGS

FIG. 1 is a schematic diagram illustrating an example of a configuration of a cloud server according to one embodiment.

FIG. 2 is a flowchart illustrating an example of a process by the cloud server according to one embodiment.

FIG. 3 is a schematic view illustrating an example of a configuration of a device according to one embodiment.

FIG. 4 is a flowchart illustrating an example of a process of the device according to one embodiment.

FIG. 5 is a diagram illustrating an example of HTML acquired by the cloud browser according to one embodiment.

FIG. 6 is a diagram illustrating an example of a drawing result generated by the cloud browser according to one embodiment.

FIG. 7 is a diagram illustrating an example of a drawing result after text input generated by the cloud browser according to one embodiment.

FIG. 8 is a diagram illustrating an example of an on-screen keyboard according to one embodiment.

FIG. 9 is a diagram illustrating an example of a processing sequence in an information processing system according to one embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

In the present embodiment, an example will be described in which a cloud server transmits information about where a text input area exists in the drawing result to the device together with the drawing result so that the device can activate the keyboard in a short time when the text input area is touched.

### <Configuration>

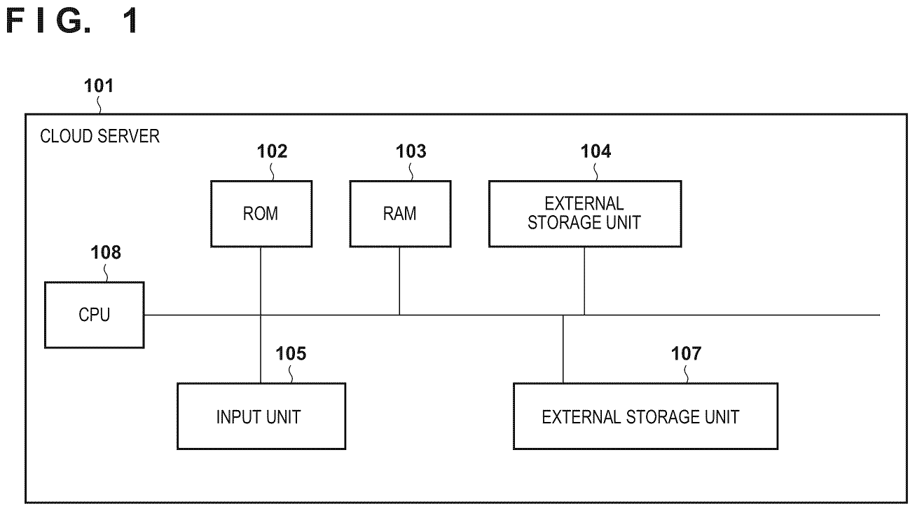

FIG. 1 is a configuration diagram illustrating an outline of a cloud server according to the present embodiment. A cloud server 101 functions as an information processing device, and includes a CPU 108, a ROM 102, a RAM 103, an external storage unit 104, an input unit 105, and a network connection interface 107. A virtual machine is saved in the external storage unit 104 of the cloud server 101, and the virtual machine is loaded into the RAM 103 and activated.

The cloud browser is executed on the virtual machine. An external web server is accessed based on a URL designated via the network connection interface 107 to acquire content constituting the Web page, and a result of processing the content is output to the RAM 103 as a drawing result.

The CPU 108 is a system control unit including one or more CPUs, and controls the entire device. The ROM 102 stores a control program of the CPU and various fixed data. The RAM 103 includes an SRAM, a DRAM, and the like, and stores a program control variable and the like. Various setting parameters and various work buffers are also stored in the RAM 103.

The external storage unit 104 is configured by a hard disk or the like, and stores file data such as documents and images. The input unit 105 includes a keyboard, a touch panel, and the like, and is used by the operator to perform various input operations. The network connection interface 107 is an interface for connecting to a network. The connection method includes a local area network (LAN), a universal serial bus (USB), and the like. Note that the configuration illustrated in FIG. 1 illustrates a part of a cloud server functioning as the drawing according to the present embodiment. In addition, in a case where the present embodiment is realized by software or the like, each block of FIG. 1 may not necessarily be held in the device.

### <Configuration of Device>

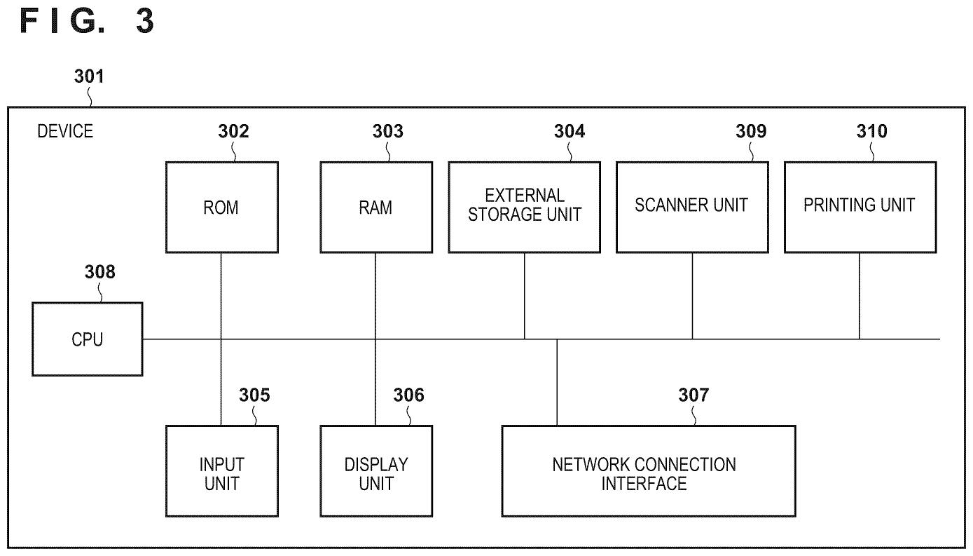

Next, FIG. 3 is a configuration diagram illustrating an outline of the device according to the present embodiment. The device 301 functions as a communication device, and includes a CPU 308, a ROM 302, a RAM 303, an external storage unit 304, an input unit 305, a display unit 306, a network connection interface 307, a scanner unit 309, and a printing unit 310.

The CPU 308 is a system control unit including one or more CPUs, and controls the entire device. The ROM 302 stores a control program of the CPU and various fixed data. The RAM 303 includes an SRAM, a DRAM, and the like, and stores a program control variable and the like. Various setting parameters and various work buffers are also stored in the RAM 303.

The external storage unit 304 is configured by a hard disk or the like, and stores file data such as documents and images. The input unit 305 includes a keyboard, a touch panel, and the like, and is used by the operator to perform various input operations. The display unit 306 is for displaying the UI to the user. The network connection interface 307 is an interface for connecting to a network. Examples of the connection method include LAN and USB. The scanner unit 309 scans a paper document. The printing unit 310 prints a document, an image, or the like. The configuration illustrated in FIG. 3 illustrates a part of the device according to the present embodiment. In addition, in a case where the present embodiment is realized by software or the like, each block of FIG. 3 may not necessarily be held in the device.

### <Processing of Cloud Server>

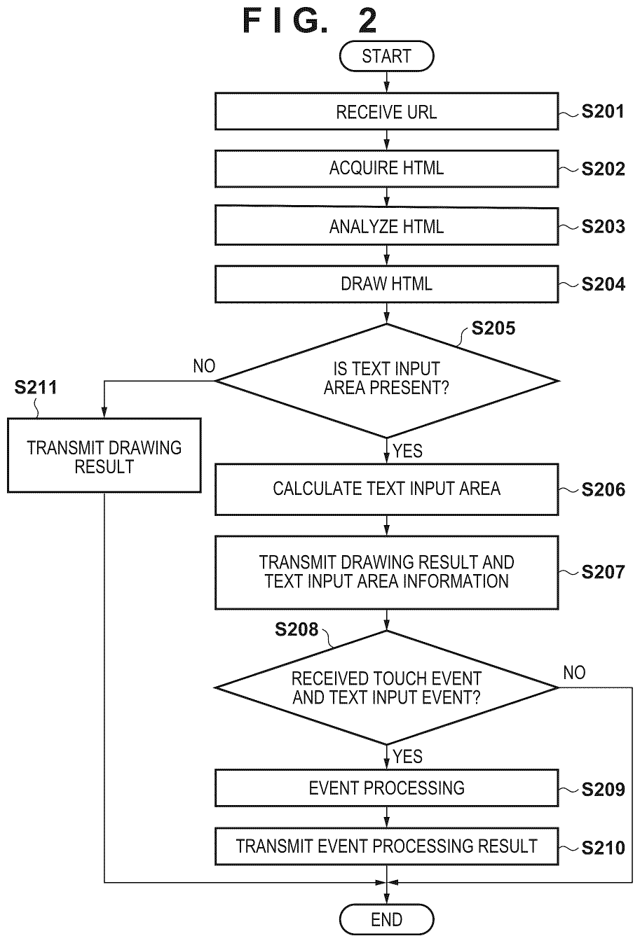

Hereinafter, the operation of the cloud server 101 according to the present embodiment will be described with reference to the flowchart of FIG. 2.

In S201, the cloud server 101 receives the URL via the network connection interface 107. The information on the received URL is saved in the RAM 103.

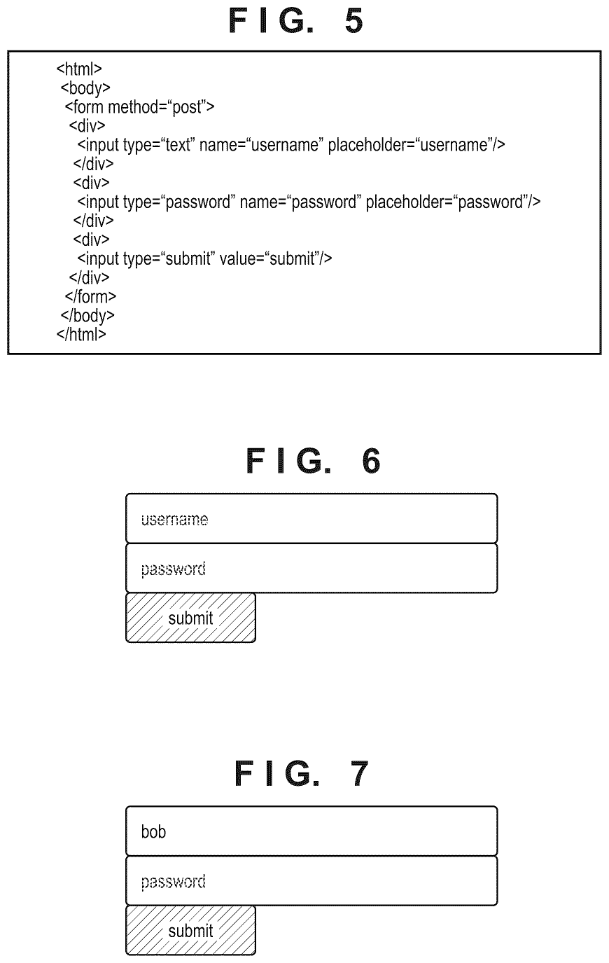

In S202, the cloud server 101 acquires HTML from Web servers providing Web pages via the network connection interface 107 based on the received URLs. The HTML is, for example, as illustrated in FIG. 5. The acquired HTML is saved in the RAM 103.

In S203, the cloud server 101 analyzes the acquired HTML. In a case where HTML refers to external CSS or JavaScript, they are also acquired via the network connection interface 107 and analyzed. The analysis result includes information indicating whether the HTML includes an <input> element that requires text input. The analysis results are saved in the RAM 103.

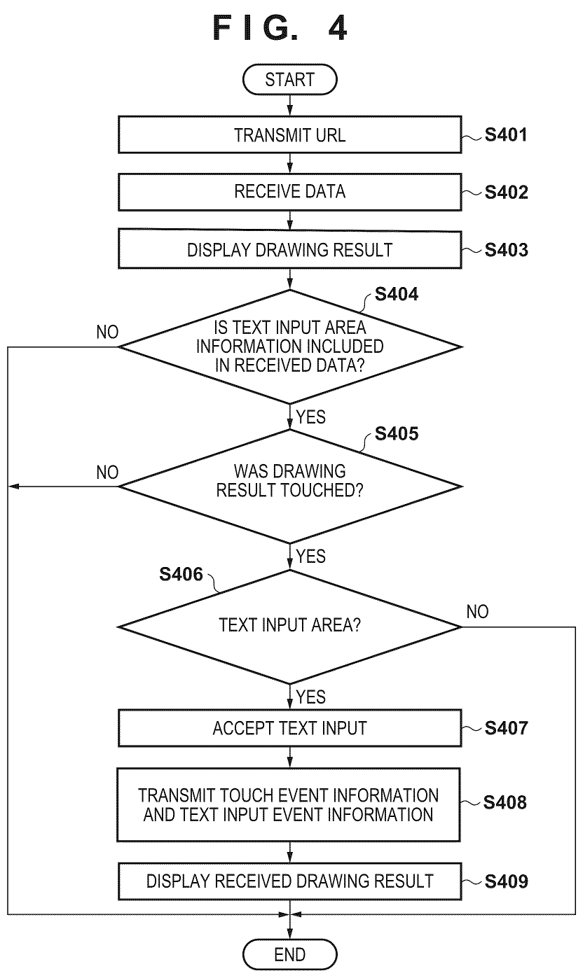

In S204, the cloud server 101 draws (renders) HTML based on the analysis result. The drawing result (rendering result) is, for example, as illustrated in FIG. 6. In the present embodiment, the screen resolution of the display unit 306 is fixed to 600×480, but may be variable. In a case of being variable, the screen resolution may be transmitted together with the URL in S401 of FIG. 4 described later. The drawing result is saved in the RAM 103 as an image file. The image file may be JPEG or PNG.

In S205, the cloud server 101 determines whether or not the text input area is included in the drawing result. In a case where it is included, the process proceeds to S206. On the other hand, in a case where it is not included, the process proceeds to S211. The text input area is expressed as an <input> element in HTML. The analysis result saved in the RAM 103 is used to determine whether or not the text input area is included.

In S206, the cloud server 101 calculates where the text input area is located in the drawing result. In the present embodiment, the HTML includes a first text input area for inputting a user's name and a second text input area for inputting a password. In the present embodiment, the text input area is a rectangle defined by arbitrary coordinates, a width, and a height, and for example, is a rectangle whose origin is the upper left of the drawing result, and is defined by the upper left coordinates, the width, and the height of the rectangle. For the calculation, getBoundingClientRect ( ) of the DOM API or the like can be used.

The first text input area is a rectangle having an x coordinate of 8, a y coordinate of 8, a width of 180, and a height of 20. The second text input area is a rectangle having an x coordinate of 8, a y coordinate of 28, a width of 180, and a height of 20. Furthermore, the text input area may be subjected to modifications such as enlargement, reduction, and rotation by CSS or JavaScript. Furthermore, the text input area information may include information such as a type attribute and a placeholder attribute which are attributes of the <input> element. Placeholder is a character string displayed when no input is made. Furthermore, the text input area information may include CSS such as a color applied to the <input> element and a width of a frame line as the style information.

In step S207, the cloud server 101 transmits the drawing result and the text input area information to the device 301 via the network connection interface 107. Data may be compressed at the time of transmission. In addition, the drawing result and the text input area information may be saved on a network, and the URL may be transmitted to the device 301.

In S208, the cloud server 101 determines whether or not a touch event and a text input event have been received from the device 301 via the network connection interface 107. In a case where it is received, the process proceeds to S209. In a case where it is not received, the process is ended.

In S209, the cloud server 101 processes the received event. In the present embodiment, since a touch event occurs in the first text input area, the first text input area enters the text input state. Furthermore, the cloud server 101 processes text input events. In the present embodiment, since the user inputs the user's name, the user's name is input in the first text input area. The cloud server 101 generates a drawing result reflecting the new HTML state and saves the drawing result in the RAM 103. The drawing result is, for example, as illustrated in FIG. 7. In the example of FIG. 7, bob is input as the user's name.

In step S210, the cloud server 101 transmits the drawing result to the device 301 via the network connection interface 107. In step S211, the cloud server 101 transmits the drawing result to the device 301 via the network connection interface 107. The above is the series of processes in FIG. 2.

### <Processing of Device>

The operation of the device 301 according to the present embodiment will be described with reference to the flowchart of FIG. 4. First, in step 401, the device 301 transmits a URL via the network connection interface 307. The communication protocol may be HTTP or HTTPS.

In S402, the device 301 receives data via the network connection interface 307. The data includes a drawing result and may further include text input area information. The received data is saved in the RAM 303.

In S403, the device 301 displays the drawing result included in the received data on the display unit 306. In the present embodiment, since the screen resolution of the display unit 306 is 600×480, the drawing result is displayed as it is, but in a case where the screen resolutions do not match, the drawing result may be enlarged or reduced. In this case, similar enlargement and reduction is applied to the text input area.

In S404, the device 301 determines whether the text input area information is included in the received data. In a case where it is included, the process proceeds to S405. On the other hand, in a case where it is not included, the process is ended.

In S405, the device 301 determines whether or not the user has touched the drawing result. In a case where touch is made, the process proceeds to S406. On the other hand, in a case where touch is not made, the process is ended. Note that a case where touch is not made may be, for example, a case where a state where touch is not made has elapsed for a certain period of time. The input unit 305 saves the touched coordinate in the RAM 303 as a coordinate having the upper left of the drawing result as an origin. In the present embodiment, the input unit 305 is a touch screen, and determines whether or not the user has touched the touch screen with a finger. Furthermore, the input unit 305 may be a pen input or a mouse input.

In S406, the device 301 determines whether or not the user has touched the text input area. In a case where the touched coordinate is included in the rectangle of the text input area, the process proceeds to S407. On the other hand, in a case where the touched coordinate is not included in the rectangle of the text input area, the process is ended.

In S407, the device 301 accepts a text input from the user. In the present embodiment, an on-screen keyboard is displayed on the display unit 306, and a user inputs a text by a touch input on a touch screen which is the input unit 305. In addition, the user may type a hardware keyboard connected to the device 301 to input text. Furthermore, the user may input a text by voice recognition.

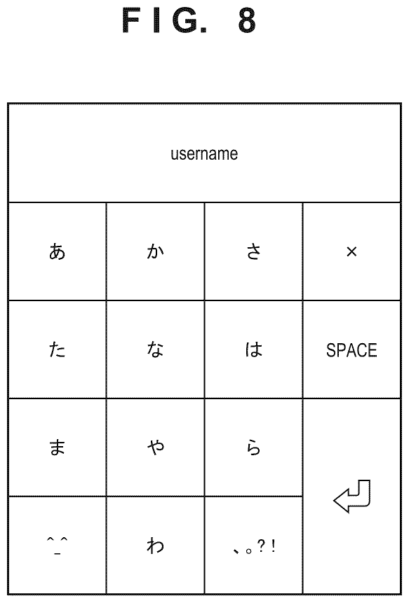

Furthermore, in a case where the text input area includes style information such as CSS, the style information may be reflected on the on-screen keyboard. For example, in a case where the placeholder attribute of the <input> element is reflected on the input area of the on-screen keyboard, the display of the display unit 306 is as illustrated in FIG. 8. As described above, by adding the HTML attribute/CSS information applied to the input form to the information of the text input area and reproducing the information on the device 301 side, it is possible to improve display consistency for the user.

In step S408, the device 301 transmits the touch event information and the text input event information to the cloud server 101 via the network connection interface 307. The information on the touch event includes information on coordinates touched by the user. The text input event information includes information of the text entered by the user with the on-screen keyboard.

In S409, the device 301 receives the drawing result via the network connection interface 307 and displays the drawing result on the display unit 306. The above is the series of processes in FIG. 4.

### <Processing Sequence>

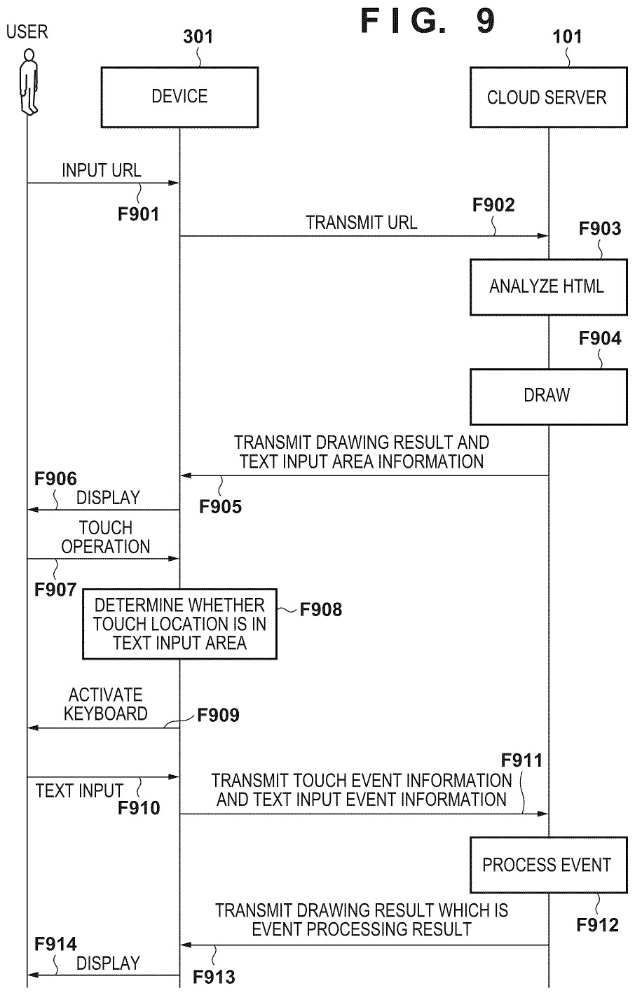

Next, a processing sequence in the information processing system including the cloud server 101 (information processing device) and the device 301 (communication device) will be described with reference to a sequence diagram in FIG. 9.

In F901, the user operates the device 301 to input URL information. In the F902, the device 301 transmits information of the input URL to the cloud server 101. In F903, the cloud server 101 acquires and analyzes HTML via the network connection interface 107 based on the received URL.

In F904, the cloud server 101 draws HTML based on the analysis result. Then, the cloud server 101 determines whether or not the text input area is included in the drawing result, and calculates where the text input area is located in the drawing result in a case where the text input area is included. In F905, the cloud server 101 transmits the drawing result and the text input area information (in a case where the drawing result includes a text input area) to the device 301.

In F906, the device 301 displays the drawing result included in the received data on the display unit 306. In F907, the user operates the device 301 to perform a touch operation. In F908, the device 301 determines whether or not the touch position is in the text input area.

In F909, in a case where the touch position is the text input area, the device 301 displays an on-screen keyboard on the display unit 306. In F910, the user operates the device 301 to input text by touch input to the touch screen which is the input unit 305.

In step F911, the device 301 transmits the touch event information and the text input event information to the cloud server 101. The information on the touch event includes information on coordinates touched by the user. The text input event information includes information of text input by the user with the on-screen keyboard.

In F912, the cloud server 101 processes the event received from the device 301 and generates a drawing result. In F913, the cloud server 101 transmits the generated drawing result, which is the event processing result, to the device 301. In F914, the device 301 displays the drawing result received from the cloud server 101 on the display unit 306. The above is the processing sequence of FIG. 9.

As described above, in the present embodiment, the cloud server acquires information about where the text input area exists in the drawing result, and transmits the information to the device together with the drawing result. As described above, by adding the information of the text input area to the drawing result, it is not necessary to newly perform communication in response to the touch operation of the user, and thus the device can activate the keyboard in a short period of time when the text input area is touched. In other words, in a case where the cloud browser is used, it is possible to reduce the time required to display the keyboard in response to the user's touch (to immediately activate the keyboard).

### Variation Example

As the storage medium for supplying the drawing program code according to the present embodiment, for example, a flexible disk, a hard disk, an optical disk, a magneto-optical disk, a CD-ROM, a CD-R, a magnetic tape, a nonvolatile memory card, a ROM, a DVD, or the like can be used.

The functions of the above-described embodiments may be realized by executing the read drawing program code by the computer. Furthermore, an operating system (OS) or the like running on the computer may perform a part or all of the actual processing based on an instruction of the drawing program code. The functions of the above-described embodiments may be realized by the processing.

Furthermore, the drawing program code read from the storage medium may be written in a memory included in a function expansion board inserted into the computer or a function expansion unit connected to the computer. Thereafter, based on the instruction of the drawing program code, a CPU or the like provided in the function expansion board or the function expansion unit may perform a part or all of the actual processing, and the functions of the above-described embodiments may be realized by such processing.

According to the present invention, in a case where a cloud browser is used, it is possible to reduce the time required to display a keyboard in response to a user's touch.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-172128, filed Oct. 3, 2023, which is hereby incorporated by reference herein in its entirety.

What is claimed is:

1. An information processing system comprising a communication device; and an information processing device that provides a drawing result of a Web page to the communication device based on a request from the communication device; wherein
the information processing device includes:
an analysis unit configured to analyze the Web page to determine a text input area, and
a transmission unit configured to transmit the drawing result and the information of the text input area to the communication device;
the communication device includes,
a reception unit configured to receive information of the text input area in the drawing result from the information processing device,
an accepting unit configured to accept an input operation from a user,
a determination unit configured to determine whether or not an operation position of the input operation is included in the text input area, and
an activation unit configured to activate a keyboard in a case where the operation position is included in the text input area.

2. The information processing system according to claim 1, wherein the information processing device further includes a reception unit configured to receive, from the communication device, input data input to the text input area in the communication device.

3. The information processing system according to claim 1, wherein the information of the text input area includes style information applied to the text input area, and
the activation unit reflects the style information on the keyboard.

4. The information processing system according to claim 1, wherein the text input area is a rectangle defined by arbitrary coordinates, a width, and a height.

5. The information processing system according to claim 1, wherein the input operation is a touch operation.

6. The information processing system according to claim 1, wherein the analysis unit determines the text input area by acquiring and analyzing HTML from a Web server that provides the Web page.

7. An information processing device that provides a drawing result of a Web page to a communication device based on a request from the communication device, the information processing device comprising:
an analysis unit configured to analyze the Web page to determine a text input area; and
a transmission unit configured to transmit the drawing result and the information of the text input area to the communication device.

8. A communication device that displays a drawing result of a Web page received from an information processing device, the communication device comprising:
a receiving unit configured to receive information of a text input area in the drawing result from the information processing device; and
an accepting unit configured to accept an input operation from a user;
a determination unit configured to determine whether an operation position of the input operation is included in the text input area; and
an activation unit configured to activate a keyboard in a case where the operation position is included in the text input area.
